(19) United States
(12) Patent Application Publication
(10) Pub. No.: US 2004/0157336 A1
(43) Pub. Date: Aug. 12, 2004

(54) Automated fluid control system and process

(75) Inventors: Christopher Petroff, Groton, MA (US); Frank McFall, North Andover, MA (US); Peter Lobban, Los Altos, CA (US); Richard Brisk, Wayland, MA (US); Eric Schultz, North Andover, MA (US); Raymond W. Leveille, Upton, MA (US)

Correspondence Address: AFFYMETRIX, INC, ATTN: CHIEF IP COUNSEL, LEGAL DEPT., 3380 CENTRAL EXPRESSWAY, SANTA CLARA, CA, 95051, US

(73) Assignee: Affymetrix, INC., Santa Clara, CA (US)

(21) Appl. No.: 10/712,860

(22) Filed: Nov. 13, 2003

Related U.S. Application Data
(60) Provisional application No. 60/426,312, filed on Nov. 14, 2002.

(51) Int. Cl. G01N 21/00

(52) U.S. Cl. 436/47; 436/43; 436/54; 422/67; 422/65; 422/100; 134/19; 134/26; 134/31; 134/36; 134/56 R

(57) ABSTRACT

A fluidics station is described that includes a housing that accepts removable modules, where each of the removable modules includes; a holder that receives a probe array cartridge, where the probe array cartridge includes a chamber that is fluidically coupled to fluid transfer apertures; a transport mechanism that reversibly transports the holder and the probe array cartridge between a first position and a second position; alignment pins constructed and arranged to engage one or more alignment features of the probe array cartridge, where the probe array cartridge is in the second position; and a needle constructed and arranged to interface with each of the fluid transfer apertures.

### RELATED APPLICATIONS

The present application claims priority to U.S. Provisional Patent Application Serial No. 60/426,312, titled “AUTOMATED FLUID CONTROL SYSTEM AND PROCESS”, filed Nov. 14, 2002, which is hereby incorporated herein by reference in its entirety for all purposes.

### FIELD OF THE INVENTION

The present invention relates to systems for automatically washing and staining high density microarrays. In particular, the invention relates to systems including elements for fluid control, and other elements such as fluid sensing.

### BACKGROUND OF THE INVENTION

Oligonucleotide probes have been long used to detect complementary nucleic acid sequences in nucleic acid of interest. In some assay formats, the oligonucleotide probe is tethered, e.g. by covalent attachment to a solid support, and arrays of oligonucleotide probes immobilized on solid supports have been used to detect specific nucleic acid sequences in target nucleic acid. See. e.g. published PCT application Nos WO 89/10977 and 89/11548.

The development of VLSIPS™ technology has provided methods for making very large arrays of polymer sequences, including polypeptides and polynucleotides, on very small substrates. See U.S. Pat. No. 5,143,854 and published PCT Application Nos. WO 90/15070 and 92/10092, each of which is incorporated herein by reference in its entirety for all purposes. U.S. patent application Ser. No. 08/082,937, filed Jun. 25, 1993, now abandoned, describes methods for making arrays of oligonucleotide probes that can be used to provide the complete sequence of a target nucleic acid and to detect the presence of a nucleic acid containing a specific nucleotide sequence. Microfabricated arrays of large numbers of oligonucleotide probes, called GeneChip® probe arrays (Affymetrix, Inc., Santa Clara, Calif.), offer great promise for a wide variety of applications, e.g., sequencing-by-hybridization techniques (SBH), gene expression monitoring, and diagnostic methods for detecting genetic and other disorders.

A major consideration in nucleic acid hybridization analyses using these arrays, as well as with other methods, is the rate at which that hybridization occurs. This hybridization rate can be affected by a variety of conditions, including the concentration of the target nucleic acid in the sample, the temperature of the hybridization reaction, the composition of the hybridization solution and others. In addition, hybridization reactions in oligonucleotide array formats are also affected by the level of mixing of the target nucleic acid during the hybridization. Such mixing typically results in the presentation of a maximal amount of target nucleic acid to the probes on the surface of the array.

Given the increased efficiency of VLSIPS™ based hybridization analyses, it is desirable to provide integrated devices which are capable of optimizing a number of the specific conditions of these hybridization reactions. In particular, it would be desirable to provide a hybridization apparatus which is capable of delivering a sample to an array, mixing the sample during hybridization, maintaining the sample at an optimal temperature for hybridization, and removing the sample from the chamber following the hybridization. Fluidics stations have been developed for carrying out repeated hybridizations of a target nucleic acid to a polymeric array of nucleic acid probes and/or the subsequent wash, staining, and other fluid-related processing steps. Such stations are described in, for example, U.S. Pat. No. 6,422,249. Such fluidics stations typically include a fluid delivery system for delivering and injecting selected fluids into an array cartridge which includes a chamber having a polymer array incorporated therein. The present invention meets these and other needs.

### SUMMARY OF THE INVENTION

The present invention generally provides novel apparatuses for rapidly and efficiently carrying out repeated hybridizations of a target nucleic acid to an array of nucleic acid probes and/or the subsequent wash, staining, and other fluid related processing steps. The apparatuses of the invention typically include a fluid delivery system for delivering and injecting in an automated fashion at least one selected fluid into at least one array cartridge which includes a chamber having a polymer array incorporated therein. The fluids may include buffers, reagents, or stains. The apparatus also includes a mounting system for holding the chamber within the array cartridge in fluid communication with the fluid delivery system. The system also includes a computer that performs the instrument control operations of the fluid control station. In some implementations the fluid control station further includes a barcode reader constructed and arranged to read one or more barcode identifiers from barcode labels associated with each of the one or more probe arrays.

A fluidics station is described that includes a housing that accepts removable modules, where each of the removable modules includes; a holder that receives a probe array cartridge, where the probe array cartridge includes a chamber that is fluidically coupled to fluid transfer apertures; a transport mechanism that reversibly transports the holder and the probe array cartridge between a first position and a second position; alignment pins constructed and arranged to engage one or more alignment features of the probe array cartridge, where the probe array cartridge is in the second position; and a needle constructed and arranged to interface with each of the fluid transfer apertures.

In some embodiments, the housing accepts up to 4 of the modules, where the holder of each of the modules receives the probe array in a specific orientation that may be defined by an alignment tab associated with the probe array cartridge and an alignment groove associated with the holder. Also, the chamber of the probe array cartridge houses a biological probe array enabled to detect biological molecules.

In the same or alternative embodiments, the transport mechanism transports the holder and probe array cartridge along a linear axis and the alignment pins precisely position the probe array cartridge that may enable the needle to introduce and remove fluid from the probe array cartridge without leaks. Additionally, some implementations may include the use of at least two needles for fluid detection, where the needles may detect the presence or absence of a fluid, and/or detect the identity of a fluid by taking conductivity measurements.

In addition some embodiments may also include a vial holder for holding vials; and a leaf spring mechanism associated with each of the vials that reversibly positions a vial needle in the bottom of the vial, where each of the vials holds a fluid and the vial needle removes the fluid from the vial for transfer to the probe array cartridge.

A method for fluid transfer is described that includes the acts of accepting removable modules, where each of the removable modules performs the acts of; receiving a probe array cartridge, where the probe array cartridge includes a chamber fluidically coupled to fluid transfer apertures; reversibly transporting the holder and the probe array cartridge between a first position and a second position; engaging one or more alignment features of the probe array cartridge where the probe array cartridge is in the second position; and interfacing with each of the fluid transfer apertures.

A fluidics module is described, that includes a holder that receives a probe array cartridge, where the probe array cartridge includes a chamber that is fluidically coupled to fluid transfer apertures; a transport mechanism that reversibly transports the holder and the probe array cartridge between a first position and a second position; alignment pins constructed and arranged to engage one or more alignment features of the probe array cartridge, where the probe array cartridge is in the second position; and a needle constructed and arranged to interface with each of the fluid transfer apertures.

In some embodiments, the fluidics module interfaces with a housing, where the housing accepts up to 4 of the fluidics modules.

A computer system having system memory with control software stored thereon is described, where the control software performs methods of instrument control that includes the acts of; receiving a probe array cartridge, where the probe array cartridge includes a chamber fluidically coupled to fluid transfer apertures; reversibly transporting the holder and the probe array cartridge between a first position and a second position; engaging one or more alignment features of the probe array cartridge where the probe array cartridge is in the second position; and interfacing with each of the fluid transfer apertures.

The above embodiments and implementations are not necessarily inclusive or exclusive of each other and may be combined in any manner that is non-conflicting and otherwise possible, whether they be presented in association with a same, or a different, embodiment or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above embodiments and implementations are illustrative rather than limiting.

### BRIEF DESCRIPTION OF THE DRAWINGS

The above and further features will be more clearly appreciated from the following detailed description when taken in conjunction with the accompanying drawings. In the drawings, like reference numerals indicate like structures or method steps and the leftmost digit of a reference numeral indicates the number of the figure in which the referenced element first appears (for example, the element 160 appears first in FIG. 1). In functional block diagrams, rectangles generally indicate functional elements and parallelograms generally indicate data. In method flow charts, rectangles generally indicate method steps and diamond shapes generally indicate decision elements. All of these conventions, however, are intended to be typical or illustrative, rather than limiting.

FIG. 1 is a functional block diagram of one embodiment of a user computer and a fluid control station;

FIG. 2A is a simplified graphical representation of one embodiment of a probe array cartridge having cartridge alignment features;

FIG. 2B is a simplified graphical representation of one embodiment of the probe array cartridge of FIG. 2A having fluid interface apertures;

FIG. 3 is a simplified graphical representation of one embodiment of a cartridge holder;

FIG. 4A is a simplified graphical representation of one embodiment of a probe array cartridge of FIGS. 2A and 2B positioned in the cartridge holder of FIG. 3;

FIG. 4B is a simplified graphical representation of one embodiment of a probe array cartridge of FIGS. 2A and 2B having a particular orientation in the cartridge holder of FIG. 3 defined by a cartridge tab and an alignment groove; and

FIG. 5 is a simplified graphical representation of one embodiment of a module housing holding removable modules.

### DETAILED DESCRIPTION OF THE PREFERRED EMBODIMENT

### Contents

I. Definitions

II. General

III. Details of the Invention

I. Definitions

The following terms are intended to have the following meanings as they are used herein.

A probe is a surface-immobilized molecule that is recognized by a particular target and is sometimes referred to as a ligand. Examples of probes that can be investigated by this invention include, but are not restricted to, agonists and antagonists for cell membrane receptors, toxins and venoms, viral epitopes, hormones (e.g., opioid peptides, steroids, etc.), hormone receptors, peptides, enzymes, enzyme substrates, cofactors, drugs, lectins, sugars, oligonucleotides or nucleic acids, oligosaccharides, proteins, and antibodies.

An “oligonucleotide” or “polynucleotide” is a nucleic acid ranging from at least 2, preferable at least 8, and more preferably at least 20 nucleotide monomers in length or a compound that specifically hybridizes to a polynucleotide. Polynucleotides of the present invention include sequences of deoxyribonucleic acid (DNA) or ribonucleic acid (RNA), which may be isolated from natural sources, recombinantly produced or artificially synthesized and mimetics thereof. A further example of a polynucleotide of the present invention may be peptide nucleic acid (PNA) in which the constituent bases are joined by peptides bonds rather than phosphodiester linkage, as described in Nielsen et al., Science 254:1497-1500 (1991), Nielsen Curr. Opin. Biotechnol., 10:71-75 (1999). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

An “array” is an intentionally created collection of molecules which can be prepared either synthetically or biosynthetically. The molecules in the array can be identical or different from each other. The array can assume a variety of formats, e.g., libraries of soluble molecules; libraries of compounds tethered to resin beads, silica chips, or other solid supports.

Nucleic acid library or array is an intentionally created collection of nucleic acids which can be prepared either synthetically or biosynthetically in a variety of different formats (e.g., libraries of soluble molecules; and libraries of oligonucleotides tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleotide sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor-made to stabilize or destabilize hybrid formation or enhance the specificity of hybridization with a complementary nucleic acid sequence as desired.

“Solid support”, “support”, and “substrate” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations.

Polymers arrays have been previously described in e.g. U.S. Pat. No. 5,143,854 and published PCT Application Nos WO 90/15070 and WO92/10092 which are incorporated herein by reference in their entireties for all purposes. These arrays may be produced using mechanical or light-directed synthesis methods which incorporate a combination of photolithographic methods and solid phase oligonucleotide synthesis methods. See Fodor et al., Science, 251:767-777 (1991), Pirrung et al., U.S. Pat. No. 5,143,854 (see also PCT Application No. WO 90/15070) and Fodor et al., PCT Publication No. WO 92/10092, all incorporated herein by reference. These references disclose methods of forming vast arrays of peptides, oligonucleotides and other polymer sequences using, for example, light-directed synthesis techniques. Techniques for the synthesis of these arrays using mechanical synthesis strategies are described in, e.g., PCT Publication No. 93/09668 and U.S. Pat. No. 5,384,261, each of which is incorporated herein by reference in its entirety for all purposes.

Various techniques and technologies may be used for synthesizing dense arrays of biological materials on or in a substrate or support. For example, Affymetrix® GeneChip® arrays are synthesized in accordance with techniques sometimes referred to as VLSIPS™ (Very Large Scale Immobilized Polymer Synthesis) technologies. Some aspects of VLSIPS™ and other microarray manufacturing technologies are described in U.S. Pat. Nos. 5,424,186; 5,143,854; 5,445,934; 5,744,305; 5,831,070; 5,837,832; 6,022,963; 6,083,697; 6,291,183; 6,309,831; and 6,310,189, all of which are hereby incorporated by reference in their entireties for all purposes. The probes of these arrays in some implementations consist of nucleic acids that are synthesized by methods including the steps of activating regions of a substrate and then contacting the substrate with a selected monomer solution. As used herein, nucleic acids may include any polymer or oligomer of nucleosides or nucleotides (polynucleotides or oligonucleotides) that include pyrimidine and/or purine bases, preferably cytosine, thymine, and uracil, and adenine and guanine, respectively. Nucleic acids may include any deoxyribonucleotide, ribonucleotide, and/or peptide nucleic acid component, and/or any chemical variants thereof such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states. Probes of other biological materials, such as peptides or polysaccharides as non-limiting examples, may also be formed. For more details regarding possible implementations, see U.S. Pat. No. 6,156,501, which is hereby incorporated by reference herein in its entirety for all purposes.

Complementary or substantially complementary: Refers to the hybridization or base pairing between nucleotides or nucleic acids, such as, for instance, between the two strands of a double-stranded DNA molecule or between an oligonucleotide primer and a primer binding site on a single-stranded nucleic acid to be sequenced or amplified. Complementary nucleotides are, generally, A and T (or A and U), or C and G. Two single-stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98% to 100%. Alternatively, substantial complementarity exists when an RNA or DNA strand will hybridize under selective hybridization conditions to its complement. Typically, selective hybridization will occur when there is at least about 65% complementarity over a stretch of at least 14 to 25 nucleotides, preferably at least about 75%, more preferably at least about 90% complementarity. See, M. Kanehisa Nucleic Acids Res. 12:203 (1984), incorporated herein by reference.

The term “hybridization” refers to the process in which two single-stranded polynucleotides bind non-covalently to form a stable double-stranded polynucleotide. The term “hybridization” may also refer to triple-stranded hybridization. The resulting (usually) double-stranded polynucleotide is a “hybrid.” The proportion of a population of polynucleotides that forms stable hybrids is referred to herein as the “degree of hybridization”.

Hybridization conditions will typically include salt concentrations of less than about 1M, more usually less than about 500 mM and less than about 200 mM. Hybridization temperatures can be as low as 5° C., but are typically greater than 22° C., more typically greater than about 30° C., and preferably in excess of about 37° C. Hybridizations are usually performed under stringent conditions, i.e. conditions under which a probe will hybridize to its target subsequence, but not to sequences to which it is not completely complementary. Stringent conditions are sequence-dependent and are different in different circumstances. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone. Generally, stringent conditions are selected to be about 5° C. lower than the thermal melting point (Tₘ) for the specific sequence at a defined ionic strength and pH. The Tm is the temperature (under defined ionic strength, pH and nucleic acid composition) at which 50% of the probes complementary to the target sequence hybridize to the target sequence at equilibrium. Typically, stringent conditions include salt concentration of at least 0.01 M to no more than 1 M Na ion concentration (or other monovalent cation) at a pH 7.0 to 8.3 and a temperature of at least 25° C. For example, conditions of 5×SSPE (750 mM NaCl, 50 mM NaPhosphate, 5 mM EDTA, pH 7.4) and a temperature of 25-30° C. are suitable for allele-specific probe hybridizations. For stringent conditions, see for example, Sambrook, Fritsche and Maniatis. “Molecular Cloning A laboratory Manual” 2^{nd} Ed. Cold Spring Harbor Press (1989) and Anderson “Nucleic Acid Hybridization” 1^{st} Ed., BIOS Scientific Publishers Limited (1999), which are hereby incorporated by reference in their entireties for all purposes above.

Hybridization probes are nucleic acids (such as oligonucleotides) capable of binding in a base-specific manner to a complementary strand of nucleic acid. Such probes include peptide nucleic acids, as described in Nielsen et al., Science 254:1497-1500 (1991), Nielsen Curr. Opin. Biotechnol., 10:71-75 (1999) and other nucleic acid analogs and nucleic acid mimetics. See U.S. Pat. No. 6,156,501 filed Apr. 3, 1996.

Hybridizing specifically to: refers to the binding, duplexing, or hybridizing of a molecule substantially to or only to a particular nucleotide sequence or sequences under stringent conditions when that sequence is present in a complex mixture (e.g. total cellular DNA or RNA).

A target is a molecule that has an affinity for a given probe and is sometimes referred to as a receptor. Targets may be naturally-occurring or manmade molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides or nucleic acids, peptides, cofactors, lectins, sugars, polysaccharides, cells, cellular membranes, and organelles. Targets are sometimes referred to in the art as anti-probes or anti-ligands. As the term “targets” is used herein, no difference in meaning is intended.

The targets are processed so that, typically, they are spatially associated with certain probes in the probe array. For example, one or more tagged targets are distributed over the probe array. In accordance with some implementations, some targets hybridize with probes and remain at the probe locations, while non-hybridized targets are washed away. These hybridized targets, with their tags or labels, are thus spatially associated with the probes and are referred to as a “probe-target pair”. A “probe-target pair” is formed when two macromolecules have combined through molecular recognition to form a complex. Detection of these pairs can serve a variety of purposes, such as to determine whether a target nucleic acid has a nucleotide sequence identical to or different from a specific reference sequence. See, for example, U.S. Pat. No. 5,837,832, referred to and incorporated above. Other uses include gene expression monitoring and evaluation (see, e.g., U.S. Pat. Nos. 5,800,992 and 6,040,138, and International Application No. PCT/US98/15151, published as WO99/05323), genotyping (U.S. Pat. No. 5,856,092), or other detection of nucleic acids, all of which are hereby incorporated by reference herein in their entireties for all purposes.

A “ligand” is a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (e.g., opiates, steroids, etc.), hormone receptors, peptides, enzymes, enzyme substrates, substrate analogs, transition state analogs, cofactors, drugs, proteins, and antibodies.

A “receptor” is a molecule that has an affinity for a given ligand. Receptors may be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term receptors is used herein, no difference in meaning is intended. A “Ligand/Receptor Pair” is formed when two macromolecules have combined through molecular recognition to form a complex. Other examples of receptors which can be investigated by this invention include but are not restricted to those molecules shown in U.S. Pat. No. 5,143,854, which is hereby incorporated by reference in its entirety.

II. General

It is the general object of the present invention to provide an apparatus for rapidly and efficiently carrying out repeated, controlled hybridization reactions with polymer arrays. Generally, the apparatuses described herein are termed fluidics stations. To accomplish the above, the fluidics stations described herein generally include a fluid delivering system for delivering a sample or a wash solution to a chamber, a fluid mixing system for mixing the sample within the chamber and/or rinsing the chamber, a temperature control system for monitoring and controlling the temperature of the chamber and a process control system for operating each of these individual systems according to a preprogrammed operating profile.

The fluidics stations herein is generally useful for performing hybridization reactions with polymer arrays and/or the subsequent wash, staining, and other fluid-related processing steps. For example, the fluidics stations may stain a hybridized array, wash a hybridized array or a stained array, and the like.

In preferred aspects, the polymer arrays include oligonucleotide arrays which include a plurality of different oligonucleotides coupled to a solid substrate in different known locations. Such polymers arrays have been previously described in e.g. U.S. Pat. No. 5,143,854 and published PCT Application Nos WO 90/15070 and WO92/10092 which are incorporated herein by reference in their entireties for all purposes.

Although generally described in terms of hybridization reactions and more specifically, nucleic acid hybridizations, and/or the subsequent wash, staining, and other fluid related processing steps, it should be appreciated that a variety of reactions may be performed using the fluidics stations of the present invention, including, e.g., extension or amplification reactions using tethered probes as template or primer sequences, screening of receptors against arrays of small molecules, peptides or peptidomimetics, polymerase chain reactions (PCR) with primer and template in solution, and the like.

In particularly preferred aspects, the fluidics stations are used in conjunction with arrays that are packaged within a housing or cartridges, like those described in, e.g. Published PCT Application No WO 95/33846, U.S. Pat. No. 6,140,044 which are incorporated herein by reference in their entireties for all purposes. In brief, the housing typically includes a body having a reaction cavity disposed therein. The array or substrate is mounted over the cavity on the body such that the front side of the array substrate, i.e. the side upon which the array has been synthesized, is in fluid communication with the cavity. The cartridge typically also includes fluid inlets and fluid outlets for flowing fluids into and through the cavity. The cartridge also typically includes alignment structures to ensure correct insertion and/or alignment of the cartridge in the fluidics station. The fluidics stations of the present invention also generally incorporate temperature monitoring and control systems for optimization of hybridization conditions. When the array is mounted upon the mounting plate, the external surface of the chamber is placed against a temperature control block. The temperature control block is coupled with a thermoelectric controller that maintains the desired temperature within the chamber by thermal exchange across a relatively thin wall of the array cartridge.

Systems, methods, and products to address these and other needs are described herein with respect to illustrative, non-limiting, implementations. Various alternatives, modifications and equivalents are possible. For example, certain systems, methods, and computer software products are described herein using exemplary implementations for analyzing data from arrays of biological materials produced by the Affymetrix® 417™ or 427™ Arrayer. Other illustrative implementations are referred to in relation to data from Affymetrix® GeneChip® probe arrays. However, these systems, methods, and products may be applied with respect to many other types of probe arrays and, more generally, with respect to numerous parallel biological assays produced in accordance with other conventional technologies and/or produced in accordance with techniques that may be developed in the future. For example, the systems, methods, and products described herein may be applied to parallel assays of nucleic acids, PCR products generated from cDNA clones, proteins, antibodies, or many other biological materials. These materials may be disposed on slides (as typically used for spotted arrays), on substrates employed for GeneChip® arrays, or on beads, optical fibers, or other substrates or media. Moreover, the probes need not be immobilized in or on a substrate, and, if immobilized, need not be disposed in regular patterns or arrays. For convenience, the term “probe array” will generally be used broadly hereafter to refer to all of these types of arrays and parallel biological assays.

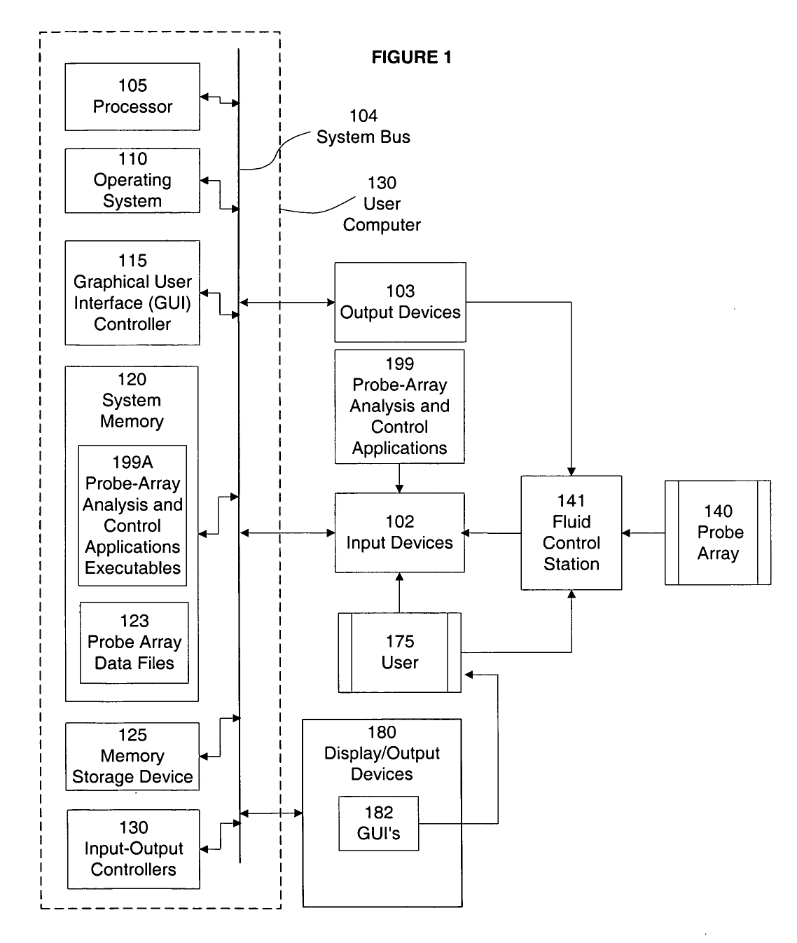

Fluid control station 141 of FIG. 1 may perform what those of ordinary skill in the related art refer to as post-hybridization operations that could include washes with buffers or reagents. The buffers could include what is referred to as a non-stringent buffer to preserve the integrity of the hybridized array until scanned. Additional post-hybridization operations include what those of ordinary skill in the art commonly refer to as staining. For example, staining includes introducing molecules with fluorescent tags that selectively bind to the biological molecules that have hybridized to the probe array. In the present example, one or more fluorescently tagged molecules may bind to each biological molecule, thus increasing the emission intensity during scanning. Also, the process of staining could include exposure of the hybridized probe array to molecules having two or more fluorescent tags with unique characteristics. The unique characteristics could include molecules that selectively bind to different hybridized biological molecules, or the fluorescent tags that have unique excitation and emission properties. For instance, a first fluorescent tag may become excited when exposed to a first wavelength of light and as a result emit light at a second wavelength. A second fluorescent tag may become excited by a third wavelength of light that could be the same as the second emitted wavelength of the first fluorescent tag, and emit a fourth wavelength of light.

Preferred implementations of fluidics stations allow for interruption of operations to insert or remove probe arrays, reagents, buffers, or any other materials. For example, a user may wish to interrupt a process conducted by a fluidics station to remove a tray of samples and insert a new tray. In the present example, a user may first input a user identifier using a computer or other type of instrument interface before interruption is allowed and subsequently input an interruption command. Confirmation of the interruption may be communicated to the user by a variety of methods, and the user performs the desired tasks. The user may then input a command for the resumption of the process.

A fluidics station may also perform operations that do not act directly upon a probe array. Such functions could include the management of fresh versus used reagents and buffers, or other materials utilized in fluid control operations. Additionally, fluidics stations may include features for leak control and isolation of components that may be sensitive to exposure to liquids. Also, fluidics stations could use data encoded on the probe array housing and/or reagent vials to adjust or define the protocols and parameters used. The data could be encoded by a variety of methods, including a barcode, magnetic strip, radio frequency identification (RFID), or other means of encoding information. For example, a probe array cartridge could include an associated barcode label that contains a unique identifier. The fluidics station obtains the unique identifier by scanning the barcode label and forwards the unique identifier to an element such as instrument control software. In the present example, the barcode label could be scanned with a hand-held reader prior to insertion into the fluidics station or alternatively the fluidics station could include one or more internal readers capable of scanning the barcode label at any time the cartridge is present within the station. Similarly, the reagent vials may have associated barcode labels that are scanned to determine the contents and locations of the vials. The instrument control software could associate the unique identifiers with data contained in an experiment or other type of data file that could include experiment protocol and parameter information. The instrument control software could then use the data associated with the unique identifiers to carry out the operations of the fluidics station. Additional examples of using barcode identifiers in instrument control are provided in U.S. patent application Ser. Nos. 10/684,160, titled “Integrated High-Throughput Microarray System and Process”, filed Oct. 10, 2003; and 10/389,194, titled “System, Method and Product for Scanning of Biological Materials”, filed Mar. 14, 2003, both of which are hereby incorporated by reference herein in their entireties for all purposes.

III. Details of the Invention

Fluid control systems and processes are now described with reference to an illustrative embodiment referred to as fluid control station 141. Station 141 is shown in a computer system environment in FIG. 1. In a typical implementation, station 141 may be used to provide fluid control and sensing without user intervention. Aspects of fluidics stations that may be included in some implementations of fluids control station 141 are described in U.S. Pat. Nos. 6,114,122; 6,391,623; 6,386,749; 6,422,249; 6,050,719; and 6,168,948 each of which are hereby incorporated by reference herein in their entireties for all purposes.

As described above, the fluidics stations described herein are typically intended for use with polymer arrays, illustrated in FIG. 1 as probe array 140. In some embodiments probe array 140 may be disposed upon some surface, such as a glass slide. Station 141 could immerse the exposed probe array in a specified volume of sample. Alternatively the sample could be applied to the surface of the probe array using some means of liquid retention.

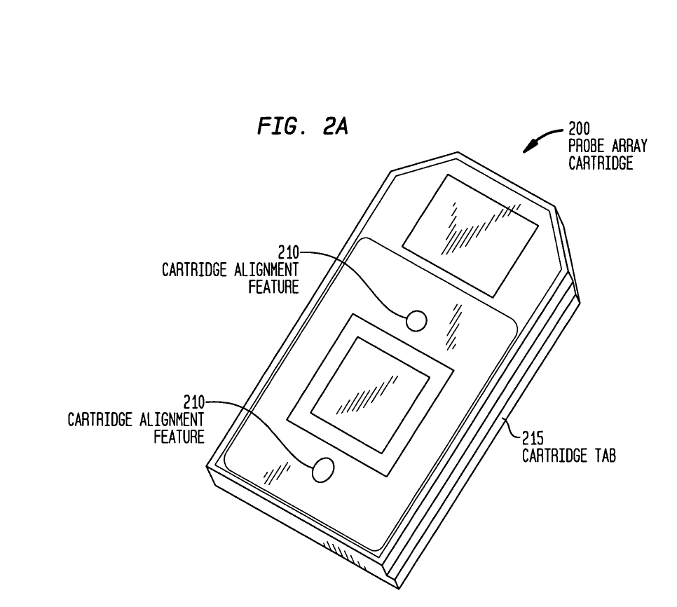

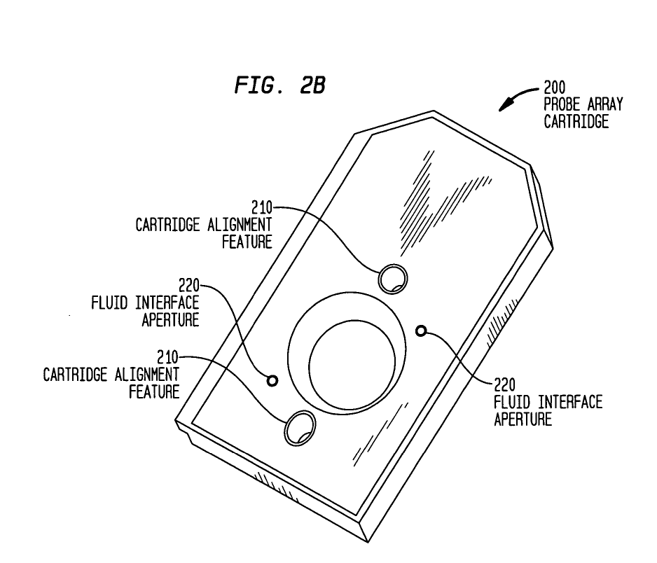

In particularly preferred aspects, the fluidics stations are used in conjunction with arrays that are packaged within a housing, like those described in, e.g., Published PCT Application No WO 95/33846, which is incorporated herein by reference in its entirety for all purposes. In brief, the housing typically includes a body having a reaction cavity disposed therein. The array is mounted over the cavity on the body such as the front side of the array substrate, i.e., the side upon which the array has been synthesized, is in fluid communication with the cavity. The cartridge also typically includes fluid inlets and fluid outlets for flowing fluid in and through the cavity. Typically, the inlet and the outlet ports will include septa disposed across the ports for sealing the ports when needles are inserted therein. For example, FIGS. 2A and 2B provides a graphical illustration of one embodiment of a housing for packaging probe arrays. FIG. 2A depicts what may be referred to as the “front” side of probe array cartridge 200, and FIG. 2B depicts the “back” side, although it will be appreciated that the terms front and back are used for illustrative purposes and should not be limiting. Elements of cartridge 200 include cartridge alignment features 210 that may provide a means for station 141 to properly position cartridge 200 for processing, fluid interface apertures 220 that may allow for the introduction and removal of fluids from cartridge 200 as well as providing an additional means for positioning, and cartridge tab 215 that may also be used by station 141 as a means for positioning cartridge 200 such as for instance by providing a unique shape that may fit in station 141 only in a specific orientation.

In some embodiments, station 141 could inject the sample into the housing or cartridge through one or more specialized ports such as, for instance, fluid interface apertures 220. In one possible implementation a port is provided to import material into the housing or cartridge and another to export it. Other implementations could include a single port used for both purposes. For example, executable 199A directs station 141 to add a specified volume of fluid to a probe array cartridge. Station 141 removes the specified volume of fluid from a reservoir via a pin, inserts the pin through a designated aperture in the probe array cartridge, and releases the volume of fluid. Alternatively, station 141 may insert the loading pin or needle through the import aperture of the probe array cartridge when the user loads the probe array into a particular position. Station 141 may deliver the sample to the pin or needle via tubing, and introduce the sample to the probe array through the pin or needle.

In the present example, a function of station 141 may include transferring a fluid from the pin or needle that removes the sample from the reservoir. Station 141 may transfer the sample to another pin, needle, or other delivery device using tubing that could, for instance, connect the reservoir pin and delivery pin.

1. Fluid Delivery System—Fiducial Features

The fluid delivery system generally includes a pump for moving the fluids, a valve assembly and manifold or tubing for selectively directing one or more different fluids to the array, and an injection system for introducing the fluid into the chamber.

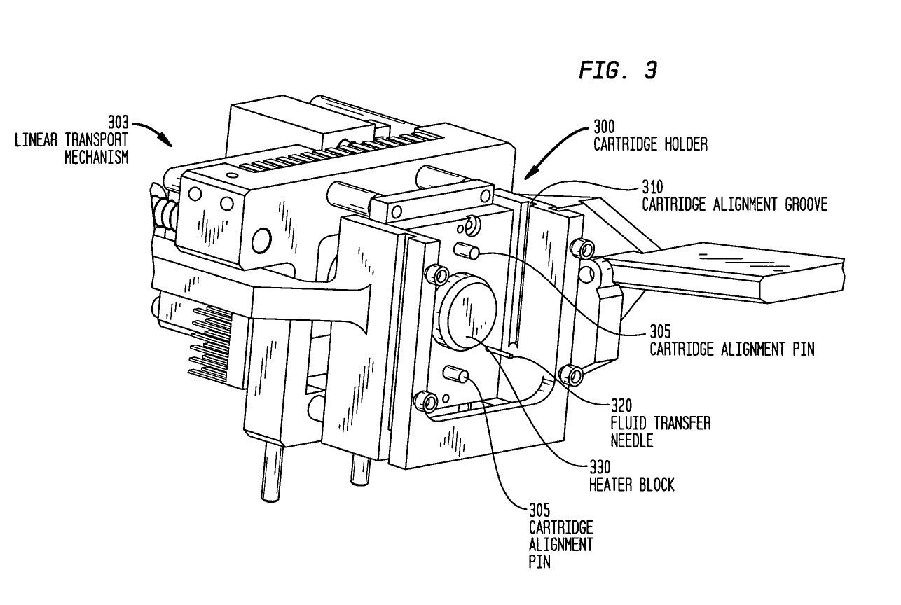

The cavity or cartridge holder of station 141 typically includes one or more alignment structures or features, e.g. alignment pins, bores and/or asymmetrical shapes to ensure correct insertion and/or alignment of the cartridge in the fluidics station. For example, FIG. 3 presents an illustrative example of cartridge holder 300 that includes elements that may be used for precisely aligning and positioning cartridge 200. Such elements include cartridge alignment pins 305, cartridge alignment groove 310, and fluid transfer pins 320. In the present example, cartridge alignment groove 310 accepts cartridge tab 215 that defines the orientation of cartridge 200 within station 141. Additionally, cartridge holder 300 may be positioned in a first position and where a user may add or remove cartridge 200. Station 141 may move cartridge holder 300 that may include cartridge 200 in a linear direction from the first position so that there is no rotation of cartridge 200 to a second position. When cartridge holder 300 with cartridge 200 is in the second position, cartridge alignment pins 305 may engage cartridge alignment features 210 so that cartridge 200 is in a preferred orientation. Continuing with the present example, the preferred orientation enables fluid transfer needles 320 to interact with fluid interface aperture 220 such that the potential for fluid leaks and damage to the pins or cartridge are minimized.

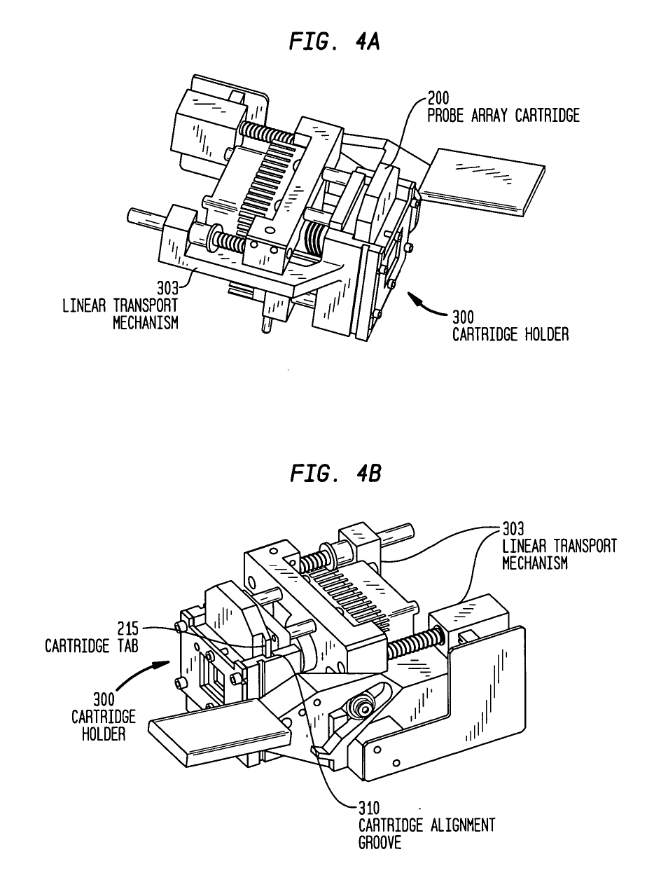

FIGS. 4A and 4B provide additional examples of probe array cartridge 200 in the second position within cartridge holder 300. Additionally, FIG. 4B illustrates the orientation of cartridge 200 as defined by the relationship of cartridge tab 215 and cartridge alignment groove 310.

Alternatively, in some embodiments station 141 may use one or more marks or fiducial features located at predetermined locations with respect to the array housing to ensure that the cartridge is positioned and aligned with greater precision than with conventional systems. For example, station 141 may implement optical, magnetic, or other type of system to identify the location of the one or more marks or fiducial features and compare against stored location(s) of the preferred positions of the mark(s) or fiducial features to apply X- Y- and Z-Cartesian coordinate directions, and rotations in the X-Y-Z planes, to urge the substrate into a reference location via positioning of cartridge holder 300.

The cartridge positioning systems and methods disclosed above ensure a correct positioning at the central location of the needle on the septum, avoiding an off-center penetration of the needle and consequently, possible leaks. In one embodiment, the fiducial and/or alignment features disclosed above would control the depth of the needle penetration. In some implementations, heater block 330 may be used to control the depth of the needles. However, the depth of the needles needs to be individually set to each heater block. For example, the depth setting may initially be performed in the factory, and subsequent resetting could be done at each field service needle replacement. In the present example, an improper depth setting could result in a too deep penetration of the needles leading to a possible perforation of what may be referred to as the wash block, or to a too shallow penetration leading to liquid leaks.

In another embodiment, the fiducial and/or alignment features protect the needles if the array is not fully inserted. For instance, if the cartridge is partially inserted, the needles can hit the array substrate and possibly could be pushed backwards. In a preferred embodiment, the fiducial and/or alignment features contact the cartridge before the insertion of the needles. In another embodiment, the fiducial and/or alignment features protect the needles from contact with the cartridge during insertion in order to prevent bending the needles. In a preferred embodiment, station 141 may include needle guards that move out of place while the needles are being inserted into the cartridge.

2. Liquid Sensing System—Conductivity Probe

To ensure proper filling of the chamber, the fluid delivery system may include sensors which indicate when the chamber has been properly filled with the selected fluid. A variety of sensors types may be used to detect the presence of the delivered fluid, such as conductivity sensors, optical sensors, thermal sensors and the like.

In a preferred aspect of the invention, a conductivity sensor may be used wherein the absence of liquid is detected by measuring the resistance between the needles that penetrate the septa that go into the array. In brief, the sensor detects a change in conductivity of the medium between two contact points in the sensor. Conductivity is a measure of conductance that refers to the ability of a material to conduct electricity. A variety of factors may affect conductivity, such as the amount of salts or other materials in a liquid. For instance a concentrated salt water solution will be more conductive than distilled water with no mineral content. Solutions can have characteristic conductivities that may be used for identification purposes.

Pins, needles, or other devices used to import liquids to and export liquids from the probe array can be used by station 141 to measure conductivity. Similarly, features may exist in the probe array cartridge that station 141 could connect to for conductivity measurement. For example, the probe array housing may have two apertures spaced some distance apart for import and export of material such as fluid interface aperture 220. Station 141 may insert a metallic pin or needle into each aperture simultaneously that could include fluid transfer needles 320. Station 141 may then apply a potential to one pin or needle while keeping the other at ground potential and measure the current flowing into the one pin or needle in order to arrive at a value of conductivity.

In another embodiment, two metallic probes are located close together in a vertical liquid channel in fluid communication with the chamber. As sample and wash solutions typically incorporate elevated level of buffers and salts, their presence may be detected by an increase in the conductivity. Additionally, the instrument control software for station 141 such as, for instance, probe array analysis and control applications executables 199A may use the measured conductivity to identify and detect if an incorrect liquid is present. For example, conductivity probes and associated software may be enabled to detect and identify liquids within a very tight conductivity range. In the present example, if the wrong liquid is presented, the executables 199A will indicate the presence of the incorrect fluid to the user via one or more means such as, for instance by displaying the error in a graphical user interface on a computer display device. Alternatively, station 141 may also include one or more means for communication with a user such as a display window or screen, one or more indicator lights, or other means known to those of ordinary skill in the related art.

In the present invention, the measured conductivity and/or liquid identity will be displayed. This display will allow the user to determine the presence or absence of liquid and more specifically which liquid e.g. wash solution, scanning buffer, or water, is actually present.

3. Linear Array Transport Mechanism

In one embodiment, the array moves linearly outward to the user instead of having the array rotate outwards to present itself to the user or linearly inward to engage with the needles that penetrate the septa. The linear transport mechanism ensures that the needles do not bend if they are not engaged properly. It also allows a proper insertion of the cartridge. In particular, the repeatable engagement of the fiduciary and/or alignment feature of the present invention is assured through the use of precision bearings and the reversible movement of the cartridge only along a single linear axis. The mechanism that allows the linear motion of the cartridge allows more space behind for grasping and removing the cartridge from the holder. For example, linear transport mechanism 303 may employ a motor driven cam to provide linear motion to cartridge holder 300.

4. Leak Path Isolation Features and Detection of Leaks

In conventional systems great effort is often exerted to create seals to separate the moisture sensitive components from the possible leak areas. Fluidics station 141 may include features for leak control and isolation from systems that may be sensitive to exposure to liquids. In one embodiment of the invention, the use of expensive and unreliable seals is avoided by the use of leak path control. In a preferred embodiment, all of the leak paths are funneled to a single channel. This allows for a rapid determination that one or more leaks may be occurring. In a more preferred embodiment, the leak path is instrumented, e.g. with sensors sensitive to moisture, to give a visual and/or audible message that a leak is occurring. As a method of automatic verification that a leak is occurring, the pump can also be used to detect a leak. The volume of tubing between the pump and the liquid detector is known. If the pump pumps more than this volume before liquid is detected, it can be used to confirm that a leak has taken place.

In another embodiment, moisture-sensitive components are located away from possible drip locations. For example, critical components, such as the rails that the array door operates on, have been placed in areas where they will not be dripped on. This way they are separated from the wet areas without the use of complex seals. In another example, the pump is protected by an internal frame member that redirects liquid away from the pump bearings. In a preferred embodiment, components that cannot be separated from the wet areas are designed to operate in a wet environment. Among these components, the needle actuator is designed to operate wet and can take the accumulation of the considerable amount of deposits before malfunctioning.

5. Modular Design

The fluidics station of the present invention may include multiple modules, e.g. single fluidics units, each module being capable of performing fluidic operations on a separate array cartridge. Each of the multiple modules may perform operations in parallel with the others, i.e., in performing the same reaction on multiple array cartridges, or may perform a number of different operations on different array cartridges.

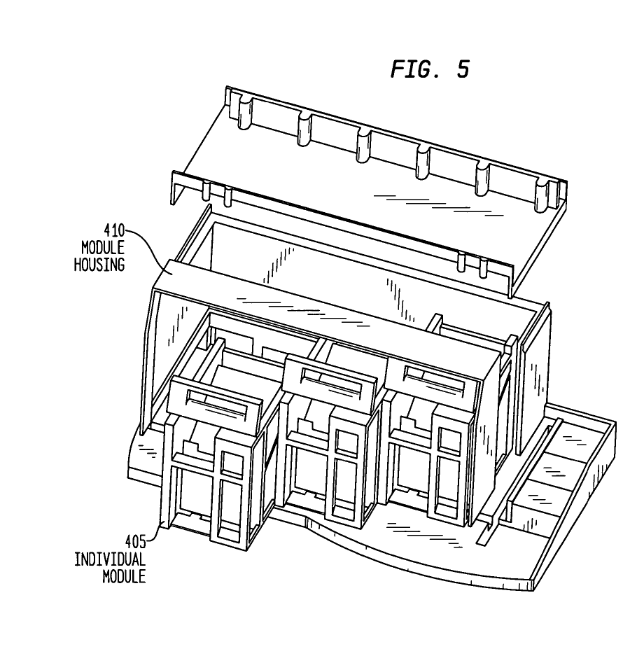

An example of modular design of the fluidics station is illustrated in FIG. 5 illustrating a module housing 410 that includes a plurality of individual modules 405. In the present example module housing 410 may be enabled to accommodate up to 4 implementations of modules 405, although those of ordinary skill in the related art will appreciate that housing 410 may be enabled to, accommodate any other number of modules 405 such as, for instance, up to 10 or more modules.

Typically each of these modules may be isolated from the others with respect to the fluid delivery, temperature control and process control systems such that multiple independent operations may be carried out at each module. A uniquely designed fluidics interface to each module allows an independent and combinatorily modular fluidics station. In such a modular design, users are no longer required to have unused and costly capacity present. Also, if a user determines a greater number of modules is required such as, for instance, for increased throughput, additional modules can be purchased and installed by the user. In the event that a particular module malfunctions, presents problems, or is undesirable for some other reason, the modular design allows its removal for repair or replacement without affecting the remaining modules.

6. Synchronized Vial Interface

Station 141 holds a plurality of experimental samples in removable reservoirs. A reservoir could include a vial, tube, bottle, or some other container suitable for holding volumes of liquid. Station 141 provides a holder or series of holders capable of receiving one or more reservoirs. The holder or series of holders may include a tray, carousel or magazine that may additionally include unique barcodes or other types of identifiers.

The positions within the holders or series of holders are known so that an experimental sample may be associated with a position and communicated to the instrument control software such as executables 199A. The detection of the absence or presence of a vial is critical for the reliable operation of the fluidics station. Station 141 also provides detectors associated with each holder to indicate to executables 199A when a reservoir is present. The detectors could, for instance, include leaf springs or other methods for detecting the presence of objects. For example, executables 199A may consult a data file that could include an experiment data file, associated with a reservoir holder identifier. The data file would contain the location information of an experimental sample that is selected by executables 199A. Executables 199A would instruct station 141 to remove a specified volume of sample from the location specified in the data file.

In one embodiment of the invention, an array of vials are loaded at the start of the test with separate liquid connections to each vial that can be addressed any time during the run of the experiment. This enables unattended operation and results in faster completion of fluidics operations as operation does not have to stop during a run to load and unload vials. For example, all vials are available at the beginning of the run and each vial may be addressed at any time during a run.

In one embodiment, given the absence and the presence of certain vials or the type of vial present, the fluidics station and/or executables 199A can select a particular script or operation to perform. In a preferred embodiment, a unique switching network enables access to the contents of the different vials without increasing the length of tubing to each vial and without moving vial contents to a central reservoir. In another embodiment, sample preparation is performed on the fluidics station by loading the vials with material that is used for sample preparation. This automates sample preparation.

7. Leaf Spring Vial Detection

The detection of the presence or the absence of a vial is critical for the reliable operation of the fluidics station. In the present invention, the detection of the vials is done according to a design that does not rely upon parts that slide across each other. In a preferred implementation, the use of a leaf spring gives a highly repeatable force to push the needle down. The needle must sit on the bottom of the vial in order for the needle to remove the entire contents of the vial. The leaf spring used provides repeatable force to bottom the needle on the vial and eliminates the potential for fatigue failure from repeating flexing. The leaf spring controls the location of sample needles without the use of sliding parts which are susceptible to lock-up.

8. User Computer

User computer 100 may be a computing device specially designed and configured to support and execute some or all of the functions of probe array applications 199, described below. Computer 100 also may be any of a variety of types of general-purpose computers such as a personal computer, network server, workstation, or other computer platform now or later developed. Computer 100 typically includes known components such as a processor 105, an operating system 110, a graphical user interface (GUI) controller 115, a system memory 120, memory storage devices 125, and input-output controllers 130. It will be understood by those skilled in the relevant art that there are many possible configurations of the components of computer 100 and that some components that may typically be included in computer 100 are not shown, such as cache memory, a data backup unit, and many other devices. Processor 105 may be a commercially available processor such as a Pentium® processor made by Intel Corporation, a SPARC® processor made by Sun Microsystems, or one of other processors that are or will become available. Processor 105 executes operating system 110, which may be, for example, a Windows®-type operating system (such as Windows NT® 4.0 with SP6a) from the Microsoft Corporation; a Unix® or Linux-type operating system available from many vendors; another or a future operating system; or some combination thereof. Operating system 110 interfaces with firmware and hardware in a well-known manner, and facilitates processor 105 in coordinating and executing the functions of various computer programs that may be written in a variety of programming languages. Operating system 110, typically in cooperation with processor 105, coordinates and executes functions of the other components of computer 100. Operating system 110 also provides scheduling, input-output control, file and data management, memory management, and communication control and related services, all in accordance with known techniques.

System memory 120 may be any of a variety of known or future memory storage devices. Examples include any commonly available random access memory (RAM), magnetic medium such as a resident hard disk or tape, an optical medium such as a read-and-write compact disc, or other memory storage device. Memory storage device 125 may be any of a variety of known or future devices, including a compact disk drive, a tape drive, a removable hard disk drive, or a diskette drive. Such types of memory storage device 125 typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory 120 and/or the program storage device used in conjunction with memory storage device 125.

In some embodiments, a computer program product is described comprising a computer-usable medium having control logic (computer software program, including program code) stored therein. The control logic, when executed by processor 105, causes processor 105 to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 130 could include any of a variety of known devices for accepting and processing information from a user, whether a human or a machine, whether local or remote. Such devices include, for example, modem cards, network interface cards, sound cards, or other types of controllers for any of a variety of known input devices 102. Output controllers of input-output controllers 130 could include controllers for any of a variety of known display devices 180 for presenting information to a user, whether a human or a machine, whether local or remote. If one of display devices 180 provides visual information, this information typically may be logically and/or physically organized as an array of picture elements, sometimes referred to as pixels. Graphical user interface (GUI) controller 115 may comprise any of a variety of known or future software programs for providing graphical input and output interfaces between computer 100 and user 175, and for processing user inputs. For instance, GUI 182 could include a graphical user interface that comprises one or more windows with one or more panes in each window. In the illustrated embodiment, the functional elements of computer 100 communicate with each other via system bus 104. Some of these communications may be accomplished in alternative embodiments using networks or other types of remote communications.

As will be evident to those skilled in the relevant art, applications 199, if implemented in software, may be loaded into system memory 120 and/or memory storage device 125 through one of input devices 102. All or portions of applications 199 may also reside in a read-only memory or similar device of memory storage device 125, such devices not requiring that applications 199 first be loaded through input devices 102. It will be understood by those skilled in the relevant art that applications 199, or portions of it, may be loaded by processor 105 in a known manner into system memory 120, or cache memory (not shown), or both, as advantageous for execution.

Probe-Array Analysis and Control Applications 199: Generally, a human being may inspect a printed or displayed image constructed from the data in an image file and may identify those cells that are bright or dim, or are otherwise identified by a pixel characteristic (such as color). However, it frequently is desirable to provide this information in an automated, quantifiable, and repeatable way that is compatible with various image processing and/or analysis techniques. For example, the information may be provided for processing by a computer application that associates the locations where hybridized targets were detected with known locations where probes of known identities were synthesized or deposited. Other methods include tagging individual synthesis or support substrates (such as beads) using chemical, biological, or electromagnetic transducers or transmitters, and other identifiers. Information such as the nucleotide or monomer sequence of target DNA or RNA may then be deduced. Techniques for making these deductions are described, for example, in U.S. Pat. No. 5,733,729, which hereby is incorporated by reference in its entirety for all purposes, and in U.S. Pat. No. 5,837,832, noted and incorporated above.

A variety of computer software applications are commercially available for controlling scanners (and other instruments related to the fluid control process that includes station 141), and for acquiring and processing the image files provided by the scanners. Examples are the Jaguar™ application from Affymetrix, Inc., aspects of which are described in PCT Application PCT/US 01/26390 and in U.S. patent applications, Ser. Nos. 09/681,819, 09/682,071, 09/682,074, and 09/682,076, the Microarray Suite application from Affymetrix, aspects of which are described in U.S. Provisional Patent Applications, Serial Nos. 60/220,587, 60/220,645 and 60/312,906, and the GeneChip® Operating Software (hereafter referred to as GCOS), aspects of which are described in U.S. Provisional Application Serial Nos. 60/442,684, titled “System, Method and Computer Software for Instrument Control and Data Acquisition, Analysis, Management and Storage”, filed Jan. 24, 2003, and 60/483,812, titled “System, Method and Computer Software for Instrument Control, Data Acquisition and Analysis”, filed Jun. 30, 2003, all of which are hereby incorporated herein by reference in their entireties for all purposes. For example, image data may be operated upon to generate intermediate results such as so-called cell intensity files (*.cel) and chip files (*.chp), generated by Microarray Suite or GCOS or spot files (*.spt) generated by Jaguar™ software. For convenience, the terms “file” or “data structure” may be used herein to refer to the organization of data, or the data itself generated or used by executables 199A and executable counterparts of other applications. However, it will be understood that any of a variety of alternative techniques known in the relevant art for storing, conveying, and/or manipulating data may be employed, and that the terms “file” and “data structure” therefore are to be interpreted broadly. In the case in which an image data file 276 is derived from a GeneChip® probe array, and in which Microarray Suite or GCOS generates a probe array intensity data file, the probe array intensity data file may contain, for each probe scanned, a single value representative of the intensities of pixels measured for that probe. Thus, this value may be a measure of the abundance of tagged cRNAs present in the target that hybridized to the corresponding probe. Many such cRNAs may be present in each probe, as a probe on a GeneChip® probe array may include, for example, millions of oligonucleotides designed to detect the cRNAs. The resulting data stored in the chip file may include degrees of hybridization, absolute and/or differential (over two or more experiments) expression, genotype comparisons, detection of polymorphisms and mutations, and other analytical results. In another example, in which executables 199A includes image data from a spotted probe array, the resulting spot file includes the intensities of labeled targets that hybridized to probes in the array. Further details regarding cell files, chip files, and spot files are provided in U.S. Provisional Patent Application Nos. 60/220,645, 60/220,587, and 60/226,999, incorporated by reference above.

In the present example, in which executables 199A include Affymetrix® Microarray Suite or GCOS, the chip file is derived from analysis of the cell file combined in some cases with information derived from library files. Laboratory or experimental data may also be provided to the software for inclusion in the chip file. For example, an experimenter and/or automated data input devices or programs may provide data related to the design or conduct of experiments. As a non-limiting example, the experimenter may specify an Affymetrix catalogue or custom chip type (e.g., Human Genome U95Av2 chip) either by selecting from a predetermined list presented by Microarray Suite or GCOS or by scanning a bar code related to a chip to read its type. Also, this information may be automatically read. For example, a barcode (or other machine-readable information such as may be stored on a magnetic strip or in memory devices of a radio transmitting module, or stored and read in accordance with any of a variety of other known techniques) may be affixed to the probe array, a cartridge, or other housing or substrate coupled to or otherwise associated with the array. The machine-readable information may automatically be read by a device (e.g., a 1-D or 2-D barcode reader) incorporated within the fluid control station, an autoloader associated with the fluid control station, an autoloader movable between the fluid control station and other instruments, and so on. In any of these cases, Microarray Suite or GCOS may associate the chip type, or other identifier, with various fluid control parameters stored in data tables. The fluid control parameters may include, for example, sequence and exposure time of fluids to the probe array, fluid levels, and so on. Rather than storing these data in data tables, some or all of them may be included in the machine-readable information coupled or associated with the probe arrays. Other experimental or laboratory data may include, for example, the name of the experimenter, the dates on which various experiments were conducted, the equipment used, the types of fluorescent dyes used as labels, protocols followed, and numerous other attributes of experiments.

As noted, executables 199A may apply some of these data in the generation of intermediate results. For example, information about the dyes may be incorporated into determinations of relative expression. Other data, such as the name of the experimenter, may be processed by executables 199A or may simply be preserved and stored in files or other data structures. Any of these data may be provided, for example over a network, to a laboratory information management server computer, such as a Laboratory information management system (LIMS) server, configured to manage information from large numbers of experiments. A data analysis program may also generate various types of plots, graphs, tables, and other tabular and/or graphical representations of analytical data. As will be appreciated by those skilled in the relevant art, the preceding and following descriptions of files generated by executables 199A are exemplary only, and the data described, and other data, may be processed, combined, arranged, and/or presented in many other ways.

The processed image files produced by these applications often are further processed to extract additional data. In particular, data-mining software applications often are used for supplemental identification and analysis of biologically interesting patterns or degrees of hybridization of probe sets. An example of a software application of this type is the Affymetrix® Data Mining Tool, described in U.S. patent application Ser. No. 09/683,980, and Affymetrix® GeneChip® Data Analysis Software (hereafter referred to as GDAS), described in U.S. Provisional Patent Application Serial No. 60/408,848, titled “System, Method, and Computer Software Product for Determination and Comparison of Biological Sequence Composition”, filed Sep. 6, 2002; and U.S. patent application Attorney Ser. No. 10/657,481, titled “System, Method, and Computer Software Product For Analysis And Display of Genotyping, Annotation, and Related Information”, filed Sep. 9, 2003, each of which is hereby incorporated herein by reference in its entireties for all purposes. Software applications also are available for storing and managing the enormous amounts of data that often are generated by probe-array experiments and by the image-processing and data-mining software noted above. An example of these data-management software applications is the Affymetrix® Laboratory Information Management System (LIMS). In addition, various proprietary databases accessed by database management software, such as the Affymetrix® EASI (Expression Analysis Sequence Information) database and database software, provide researchers with associations between probe sets and gene or EST identifiers.

For convenience of reference, these types of computer software applications (i.e., for acquiring and processing image files, data mining, data management, and various database and other applications related to probe-array analysis) are generally and collectively represented in FIG. 1 as probe-array analysis and control applications199. FIG. 1 illustratively shows applications 199 stored for execution (as executable code 199A corresponding to applications 199) in system memory 120 of user computer 100.

As will be appreciated by those skilled in the relevant art, it is not necessary that applications 199 be stored on and/or executed from computer 100; rather, some or all of applications 199 may be stored on and/or executed from an applications server or other computer platform to which computer 100 is connected in a network. For example, it may be particularly advantageous for applications involving the manipulation of large databases to be executed from a database server. Alternatively, LIMS, DMT, and/or other applications may be executed from computer 100, but some or all of the databases upon which those applications operate may be stored for common access on a server (perhaps together with a database management program, such as the Oracle® 8.0.5 database management system from Oracle Corporation). Such networked arrangements may be implemented in accordance with known techniques using commercially available hardware and software, such as those available for implementing a local-area network or wide-area network. A local network is represented in FIG. 1 by the connection of user computer 100 to fluid control station 141 via a network cable, wireless network, or other means of networking known to those in the related art

In some implementations, it may be convenient for user 175 to group probe-set identifiers for batch transfer of information or to otherwise analyze or process groups of probe sets together. For example, as described below, user 175 may wish to obtain annotation information related to one or more probe sets identified by their respective probe set identifiers. Rather than obtaining this information serially, user 175 may group probe sets together for batch processing. Various known techniques may be employed for associating probe set identifiers, or data related to those identifiers, together. For instance, user 175 may generate a tab delimited text file including a list of probe set identifiers for batch processing. This file or another file or data structure for providing a batch of data (hereafter referred to for convenience simply as a “batch file”), may be any kind of list, text, data structure, or other collection of data in any format. The batch file may also specify what kind of information user 175 wishes to obtain with respect to all, or any combination of, the identified probe sets. In some implementations, user 175 may specify a name or other user-specified identifier to represent the group of probe-set identifiers specified in the text file or otherwise specified by user 175. This user-specified identifier may be stored by one of executables 199A, so that user 175 may employ it in future operations rather than providing the associated probe-set identifiers in a text file or other format. Thus, for example, user 175 may formulate one or more queries associated with a particular user-specified identifier, resulting in a batch transfer of information from an internet portal to user 175 related to the probe-set identifiers that user 175 has associated with the user-specified identifier. Alternatively, user 175 may initiate a batch transfer by providing the text file of probe-set identifiers. In any of these cases, user 175 may provide information, such as laboratory or experimental information, related to a number of probe sets by a batch operation rather than by serial ones. The probe sets may be grouped by experiments, by similarity of probe sets (e.g., probe sets representing genes having similar annotations, such as related to transcription regulation), or any other type of grouping. For example, user 175 may assign a user-specified identifier (e.g., “experiments of January 1”) to a series of experiments and submit probe-set identifiers in user-selected categories (e.g., identifying probe sets that were up-regulated by a specified amount) and provide the experimental information for data storage and/or analysis.

Given these various embodiments and implementations, it should be apparent to those skilled in the relevant art that the foregoing is illustrative only and not limiting, having been presented by way of example only. Many other schemes for distributing functions among the various functional elements of the illustrated embodiment are possible. The functions of any element may be carried out in various ways in alternative embodiments. For example, some or all of the functions described as being carried out by graphical user interface (GUI) controller 115 could be carried out by input-output controllers 130, or these functions could otherwise be distributed among other functional elements. Also, the functions of several elements may, in alternative embodiments, be carried out by fewer, or a single, element. For example, the functions of controller 115 and controllers 130 could be carried out by a single element in other implementations. Similarly, in some embodiments, any functional element may perform fewer, or different, operations than those described with respect to the illustrated embodiment. Also, functional elements shown as distinct for purposes of illustration may be incorporated within other functional elements in a particular implementation.

Also, the sequencing of functions or portions of functions generally may be altered. Certain functional elements, files, data structures, and so on, may be described in the illustrated embodiments as located in system memory of a particular computer. In other embodiments, however, they may be located on, or distributed across, computer systems or other platforms that are co-located and/or remote from each other. For example, any one or more of data files or data structures described as co-located on and “local” to a server or other computer may be located in a computer system or systems remote from the server. In addition, it will be understood by those skilled in the relevant art that control and data flows between and among functional elements and various data structures may vary in many ways from the control and data flows described above or in documents incorporated by reference herein. More particularly, intermediary functional elements may direct control or data flows, and the functions of various elements may be combined, divided, or otherwise rearranged to allow parallel processing or for other reasons. Also, intermediate data structures or files may be used and various described data structures or files may be combined or otherwise arranged. Numerous other embodiments, and modifications thereof, are contemplated as falling within the scope of the present invention as defined by appended claims and equivalents thereto.

The above embodiments and implementations are not necessarily inclusive or exclusive of each other and may be combined in any manner that is non-conflicting and otherwise possible, whether they be presented in association with a same, or a different, embodiment or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above embodiment and implementations are illustrative rather than limiting.

What is claimed is:

1. A fluidics station, comprising:
a housing constructed and arranged to accept one or more removable modules, wherein each of the one or more removable modules comprises:
a holder constructed and arranged to receive a probe array cartridge, wherein the probe array cartridge includes a chamber fluidically coupled to a plurality of apertures;
a transport mechanism constructed and arranged to reversibly transport the holder and the probe array cartridge between a first position and a second position;
one or more alignment pins constructed and arranged to engage one or more alignment features of the probe array cartridge, wherein the probe array cartridge is in the second position; and
a needle constructed and arranged to interface with each of the plurality of apertures.

2. The station of claim 1, wherein:
the housing accepts up to 4 of the modules.

3. The station of claim 1, wherein:
the holder receives the probe array in a specific orientation.

4. The station of claim 3, wherein:
the specific orientation is defined by an alignment tab associated with the probe array cartridge and an alignment groove associated with the holder.

5. The station of claim 1, wherein:
the chamber houses a biological probe array enabled to detect biological molecules.

6. The station of claim 1, wherein:
the transport mechanism transports the holder and probe array cartridge along a linear axis.

7. The station of claim 1, wherein:
the one or more alignment pins precisely position the probe array cartridge.

8. The station of claim 1, wherein:
the needle introduces and removes fluid from the probe array cartridge.

9. The station of claim 1, wherein:
at least two needles interfacing with the plurality of apertures are further constructed and arranged for fluid detection.

10. The station of claim 9, wherein:
the fluid detection includes conductivity measurements.

11. The station of claim 9, wherein:
the fluid detection includes the presence or absence of a fluid.

12. The station of claim 9, wherein:
the fluid detection includes the identity of a fluid.

13. The station of claim 1, wherein each module further comprises:
a vial holder constructed and arranged to hold a plurality of vials; and
a leaf spring mechanism associated with each of the plurality of vials constructed and arranged to reversibly position a vial needle in the bottom of the vial.

14. The station of claim 13, wherein:
each of the plurality of vials holds a fluid.

15. The station of claim 14, wherein:
the vial needle removes the fluid from the vial for transfer to the probe array cartridge.

16. A method for fluid transfer, comprising the acts of:
accepting one or more removable modules, wherein each of the one or more removable modules performs the acts of:
receiving a probe array cartridge, wherein the probe array cartridge includes a chamber fluidically coupled to a plurality of apertures;
reversibly transporting the holder and the probe array cartridge between a first position and a second position;
engaging one or more alignment features of the probe array cartridge, wherein the probe array cartridge is in the second position; and
interfacing with each of the plurality of apertures.

17. The method of claim 16, wherein:
the housing accepts up to 4 of the modules.

18. The method of claim 16, wherein:
the holder receives the probe array in a specific orientation.

19. The method of claim 18, wherein:
the specific orientation is defined by an alignment tab associated with the probe array cartridge and an alignment groove associated with the holder.

20. The method of claim 16, wherein:
the chamber houses a biological probe array enabled to detect biological molecules.

21. The method of claim 16, wherein:
the act of reversibly transporting includes transporting along a linear axis.

22. The method of claim 16, wherein each removable module further performs the acts of:
detecting fluid via the interface with at least two of the plurality of apertures.

23. The method of claim 22, wherein:
the act of detecting fluid includes conductivity measurements.

24. The method of claim 22, wherein:
the act of detecting fluid includes detecting the presence or absence of a fluid.

25. The method of claim 22, wherein:
the act of detecting fluid includes detecting the identity of a fluid.

26. The method of claim 16, wherein each removable module further performs the acts of:
holding a plurality of vials; and
reversibly positioning a vial needle in the bottom of each vial.

27. The method of claim 26, wherein:
each of the plurality of vials holds a fluid.

28. The method of claim 27, further comprising the act of:
removing the fluid from the vial for transfer to the probe array cartridge.

29. A fluidics module, comprising:
a holder constructed and arranged to receive a probe array cartridge, wherein the probe array cartridge includes a chamber fluidically coupled to a plurality of apertures;
a transport mechanism constructed and arranged to reversibly transport the holder and the probe array cartridge between a first position and a second position;
one or more alignment pins constructed and arranged to engage one or more alignment features of the probe array cartridge, wherein the probe array cartridge is in the second position; and
a needle constructed and arranged to interface with each of the plurality of apertures.

30. The module of claim 29, wherein:
the fluidics module is further constructed and arranged to interface with a housing, wherein the housing accepts up to 4 of the fluidics modules.

31. The module of claim 29, wherein:
the holder receives the probe array in a specific orientation.

32. The module of claim 31, wherein:
the specific orientation is defined by an alignment tab associated with the probe array cartridge and an alignment groove associated with the holder.

33. The module of claim 29, wherein:
the chamber houses a biological probe array enabled to detect biological molecules.

34. The module of claim 29, wherein:
the transport mechanism transports the holder and probe array cartridge along a linear axis.

35. The module of claim 29, wherein:
the one or more alignment pins precisely position the probe array cartridge.

36. The module of claim 29, wherein:
the needle introduces and removes fluid from the probe array cartridge.

37. The module of claim 29, wherein:
at least two needles interfacing with the plurality of apertures are further constructed and arranged for fluid detection.

38. The module of claim 37, wherein:
the fluid detection includes conductivity measurements.

39. The module of claim 37, wherein:
the fluid detection includes the presence or absence of a fluid.

40. The module of claim 37, wherein:
the fluid detection includes the identity of a fluid.

41. The module of claim 29, wherein each module further comprises:
a vial holder constructed and arranged to hold a plurality of vials; and
a leaf spring mechanism associated with each of the plurality of vials constructed and arranged to reversibly position a vial needle in the bottom of the vial.

42. The module of claim 41, wherein:
each of the plurality of vials holds a fluid.

43. The module of claim 42, wherein:
the vial needle removes the fluid from the vial for transfer to the probe array cartridge.

44. A computer system having system memory with control software stored thereon, wherein the control software performs methods of instrument control comprising the acts of:
receiving a probe array cartridge, wherein the probe array cartridge includes a chamber fluidically coupled to a plurality of apertures;
reversibly transporting the holder and probe array cartridge between a first position and a second position, wherein the act of reversibly transporting includes transporting along a linear axis;
engaging one or more alignment features of the probe array cartridge, wherein the probe array cartridge is in the second position; and
interfacing with each of the plurality of apertures.
